(19) United States
(12) Patent Application Publication
(10) Pub. No.: US 2011/0093127 A1
(43) Pub. Date: Apr. 21, 2011

(54) DISTRIBUTED ENERGY RESOURCES MANAGER

(75) Inventor: David Kaplan, Seattle, WA (US)

(73) Assignee: David L. Kaplan, Seattle, WA (US)

(21) Appl. No.: 12/905,292

(22) Filed: Oct. 15, 2010

Related U.S. Application Data
(60) Provisional application No. 61/252,225, filed on Oct. 16, 2009.

(51) Int. Cl. G06F 1/28

(52) U.S. Cl. 700/292; 700/297; 700/295

(57) ABSTRACT

A Distributed Energy Resources Manager may serve to connect electrical assets in an electricity distribution grid with other information-processing systems including, but not limited to, existing utility grid management systems to manage flows of information between electrical assets and interacting software assets and, thereby, manage performance of at least the electrical assets.

### PRIORITY

The present application claims priority to provisional U.S. patent application entitled “Electricity Distribution Management System,” U.S. provisional No. 61/252,225 filed in the U.S. Patent and Trademark Office on Oct. 16, 2009.

### FIELD

The embodiments described herein include systems, methods, and programs for managing distributed energy resources.

### BACKGROUND

Typically, electric power systems implements three major functions. The first function is the generation of electrical power by any of several means including burning fossil fuels (such as coal, oil or natural gas), nuclear fission, hydroelectric turbines, wind turbines, solar photovoltaic panels, etc. The second function is the transmission of electrical power, typically over long distances at high voltages, from sources of generation to points of distribution such as substations. Sub-transmission may bridge between transmission and distribution voltages. The third function is the distribution of transmitted electrical power, typically over relatively short distances and at relatively lower voltages, from points of distribution such as substations to end customers. Energy storage, utilizing devices such as batteries, flywheels, capacitors, compressed-air storage systems, pumped hydroelectric systems, or reversible electro-chemical conversion devices such as fuel cells, may become a further significant power system function in the future.

In addition, electric utilities in many jurisdictions are typically required by regulatory authorities to manage these electric power systems so as to meet public-interest standards of reliability and economy.

As a result, finances and resources are being invested in the development and usage of clean sources of electric power, such as wind, solar (photovoltaic or thermal), ocean (tidal, wave or thermal), geothermal or hydroelectric power, all of which may serve as significant means of reducing the burning of fossil fuels, which produces greenhouse gas emissions and toxic pollutants. Accordingly, deployment of such clean electric power sources is likely to increase over present usage levels.

However, because clean power mechanisms depend upon naturally-occurring primary energy sources, such as the wind, sun or tides, they generally produce power only intermittently. Thus, there arises a conflict between supply and demand.

Accordingly, societal and governmental demands to limit greenhouse gas production, increase clean power generation, and track carbon credits may be increasingly placed upon electric power systems. As such demands occur, managing electricity distribution grids may become more complex and hence more difficult for electric utilities.

Solutions for addressing this management complexity have included placing devices or systems to distribute generation, manage demand-side assets, store electrical energy, correct power factor, and/or improve power quality within a distribution grid or on customer premises.

Currently, electricity distribution grids may be equipped with field switches to enable the electrical connection or isolation of distribution grid subsections under grid operator or automated system control. Such field switches may be kept in a normally-open or normally-closed state. When a normally-open switch is closed, it connects adjacent distribution grid subsections that are normally disconnected from one another. Conversely, when a normally-closed switch is opened, it disconnects adjacent distribution grid subsections that are normally connected to one another. By closing switches that are normally opened, the distribution system topology can be changed from radial to looped or meshed to add additional reliability and other benefits to the system.

Further, electricity distribution grids or customer premises may be equipped with metering or sub-metering devices that measure current, voltage, impedance, inductance, capacitance, power factor or other characteristics of electric power flow for purposes of billing, monitoring or enabling control of electric system assets. Such metering or sub-metering devices may communicate with electric utility software via advanced metering infrastructure (AMI) systems.

Further still, electricity distribution grid assets, such as relays, field switches, re-closers, capacitor banks or transformers, and devices or systems to perform demand-side management, electrical energy storage, etc. may be communicatively connected with grid operations centers via telemetry for purposes including data exchange, monitoring of asset performance, and controlling of the assets.

In addition, electric utilities deploy systems for managing existing transmission grid assets. Such systems may be referred to as energy management systems (EMS) or supervisory control and data (SCADA) systems. Further still, electric utilities may deploy systems for managing existing distribution grid assets. Such systems may be called distribution management systems (DMS). Still further, electric utilities may deploy systems for managing power outages. Such systems may be called an outage management system (OMS).

Existing utility grid management systems, such as EMS, SCADA, DMS or OMS systems, may benefit from communicative connections with devices or systems for electrical energy storage or asset management systems for management of demand-side assets such as electric vehicles or air conditioners, for purposes of data exchange, monitoring or control.

Certain classes of electric load, e.g., air conditioners, electric vehicles, residential energy use or industrial battery charging, may be managed by existing asset management systems as aggregated, or unitary, loads. Emerging standards for communication protocols intended for managing data exchange, monitoring performance, and controlling distribution grid assets and grid control systems may be implemented by industry or regulatory authorities, thus accelerating overall market growth.

Electric utilities may purchase or procure electric power on a short- or long-term basis from other electric utilities, independent power producers, or electric power marketers. In making such purchases or procurements, electric utilities may need to assess, in real-time, how to best meet public-interest standards of reliability and economy as required by regulatory authorities.

### SUMMARY

A Distributed Energy Resources Manager may serve to connect electrical assets in an electricity distribution grid with other information-processing systems including, but not limited to, existing utility grid management systems to manage flows of information between electrical assets and interacting software assets and, thereby, manage performance of at least the electrical assets. Such management includes communicating with one or more of the electrical assets connected to an electricity distribution grid, communicating with one or more switches within the electricity distribution grid, and optimizing operation of either of the electrical assets and switches based on messages resulting from the aforementioned communications to thereby improve the flow of electric power within the grid.

### BRIEF DESCRIPTION OF THE DRAWINGS

In the detailed description that follows, embodiments are described as illustrations only since various changes and modifications will become apparent to those skilled in the art from the following detailed description. The use of the same reference numbers in different figures indicates similar or identical items.

FIG. 1 shows a system to disclose an example information flow between an existing management system and an example distributed energy resource manager (DERM).

FIG. 2 shows an example iteration of the system of FIG. 1 to disclose an example communication flow between various subsystems and various grid assets in accordance with example embodiments of DERM.

FIG. 3 shows an example distribution grid topology for implementing examples of DERM.

FIG. 4 shows an example of DERM between an existing utility system and a transformer.

FIG. 5 shows an example of a management flow according to at least one embodiment of DERM.

FIG. 6 shows an example of a general computer network environment that may be used to implement the techniques described herein.

### DETAILED DESCRIPTION

Described herein are systems, apparatuses, and methods related to managing flows of information between electrical assets and interacting software assets. The aforementioned management may be implemented by a Distributed Energy Resources Manager (alternately referred to herein as “DERM”); and the interacting software assets thereof may serve to connect such electrical assets with other information-processing systems including, but not limited to, existing utility grid management systems such as supervisory control and data systems (SCADA), energy management systems (EMS), distribution management systems (DMS), or outage management systems (OMS), as described herein. Examples of the management of electrical assets include distributed generation of energy, energy storage, and managed load.

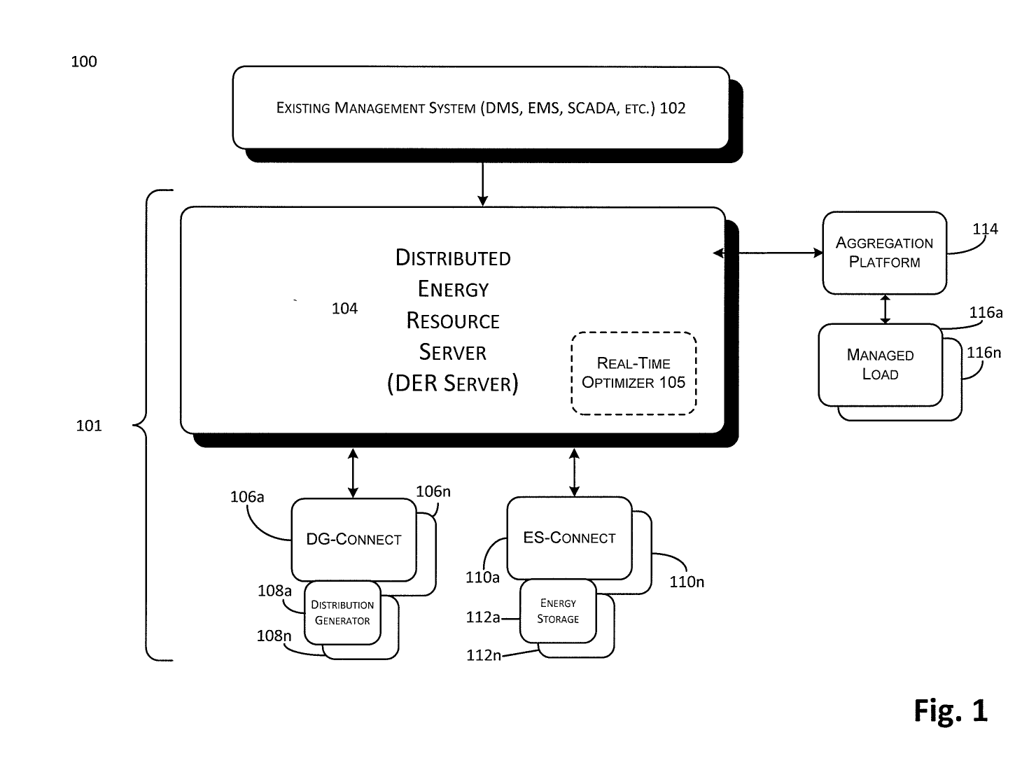

FIG. 1 shows an example system 100 by which a distributed energy resource (DER) manager 101 manages distribution system assets, which may include, for example, energy storage systems and sub-systems, distributed generation systems and sub-systems, and managed load systems and sub-systems.

More particular, example DER manager 101 may include DER server 104, which may interface with at least one of utility DMS, EMS, and SCADA systems 102. DER server 104 may further interface with third-party aggregation platforms 114 for managing one or more implementations of managed loads 116a . . . 116n (n is an integer), such as HVAC, water heaters, electric vehicle (EV) charging stations, etc.

According to at least one embodiment of DER manager 101, DER server 104 may include real-time optimizer 105.

DER manager 101 may further include one or more implementations of (DG)-connect hardware, software, or firmware 106a . . . 106n to communicate with, monitor, or manage one or more implementations of distributed generation systems 108a . . . 108n, likely, though not necessarily so, on a one-to-one basis.

DER manager 101 may still further include one or more implementations of (ES)-connect hardware, software, or firmware 110a . . . 110n to communicate with, monitor, or manage energy storage devices 112a . . . 112n, likely, though not necessarily so, on a one-to-one basis.

In a remote dispatch scenario for DER manager 101, a program associated with DER server 104 may accept signal from an existing management system 102 and dispatch one or more of energy storage devices 112a . . . 112n via one or more of (ES)-connect devices 110a . . . 110n, or managed load, via one or more aggregation platform(s) 114, in response thereto. DER server 104 may further invoke real-time optimizer 105 to optimize said dispatch as to timing, amount of power dispatched or other quantity. Accordingly, distributed resources may be utilized to meet system-wide needs such as reducing peak consumption; storing excess utility-scale wind or solar power; responding to price signals including, but not limited to, real-time or critical peak pricing; or supply ancillary grid services.

In a local dispatch scenario for DERM 101, a program associated with DER server 104 may monitor the distributed generation of energy, e.g., residential or commercial rooftop solar photovoltaic (PV) systems; and may dispatch one or more of energy storage devices 112a . . . 112n via one or more of (ES)-connect devices 110a . . . 110n, or managed load, via one or more aggregation platform(s) 114, in response thereto. DER server 104 may further invoke real-time optimizer 105 to optimize said dispatch as to timing, amount of power dispatched or other quantity.

Accordingly, DER manager 101 may enable, for example, utility owned community energy storage systems in a distribution grid to offset real-time fluctuations in solar PV output, e.g., during cloud coverage.

In a microgrid management scenario for DER manager 101, a program associated with DER server 104 may enable utilities to establish micro grids, which match sub-programs associated with DER server 104 with geographically or grid-topologically proximate units of distributed generation 108a . . . 108n, distributed energy storage 112a . . . 112n, or managed loads 116a . . . 116n.

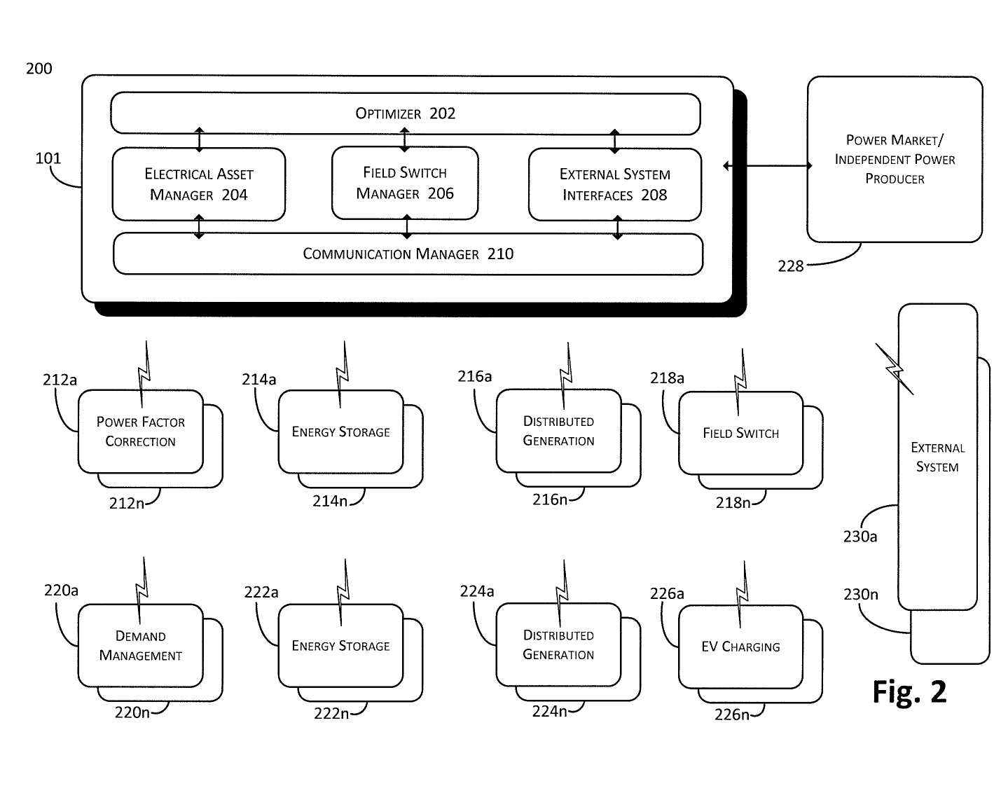

FIG. 2 shows an example of how DERM 101 may communicatively connect with, and manage, electrical assets that are owned by an electric utility and located within a distribution grid or that are owned by an electric utility's customer and located on the customer's premises. In the figure, the aforementioned communicative connections are denoted by a lightning bolt symbol.

DERM 101 may be implemented as a combination of software running on general-purpose computing systems, such as Windows- or Linux-based servers in an internet-connected data center, and embedded hardware, software and communications incorporated into electrical assets deployed in an electricity distribution grid or on customer premises for purposes of distributed generation, demand-side management, energy storage, power factor correction, power quality improvement, or other means of improving the reliability and/or economy of distribution grid operation.

Communication between electrical assets and a DERM can occur over any available communication channel or combination of channels and may involve other components, such as a utility-owned smart meter or customer-owned energy management terminals.

In FIG. 2, the example embodiment of DERM 101 may have subsystems that include, e.g., communication manager 210 to manage data-level connections between external entities 212-230 and DERM 101; electrical asset manager 204 to manage application-level connections between electrical assets, such as energy storage 214a . . . 214n, distributed generation 216a . . . 216n, etc. and DERM 101; field switch manager 206 to manage application-level connections between distribution grid field switches 218a . . . 218n and DERM 101; external system interfaces 208 to manage application-level connections between DERM 101 and external asset management 230a . . . 230n, including, e.g., EMS, SCADA, DMS or OMS systems; and optimizer 202 to optimize delivery of electrical power to or within an electricity distribution grid or subsection thereof by manipulating properties of electrical assets, field switches, and/or external asset management systems.

Among its capabilities, DERM 101 may facilitate the determination of an optimal distribution grid topology and may further allow for operator/customer defined optimization and extensibility to handle scenarios that may be specific to customer needs. An example of the aforementioned distribution grid may include one that enables a communicative connection between at least one of external nodes 212a . . . 226n and DERM 101 and a plurality of electrical assets.

As an example of determining an optimal distribution grid topology, DERM 101 may allow utility operators to specify allowable temporary overload conditions on electrical assets connected to a distribution grid and the associated financial costs for distributing stored energy thereto. Given this information, when DERM 101 receives a message requesting help in response to a temporary adverse condition, DERM 101 may calculate a cost effective solution that avoids distribution interruption and reduces a risk of overloading assets.

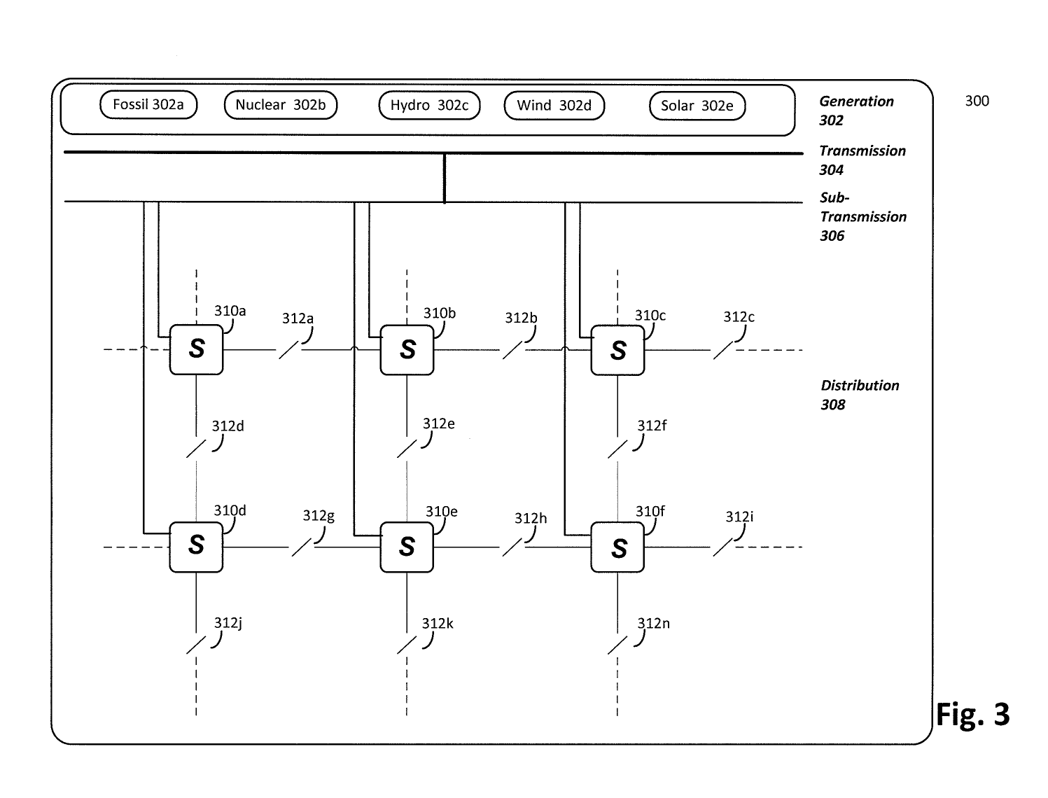

FIG. 3 shows an example distribution grid topology 300 that may be managed by DERM 101, as set forth above.

In the grid topology 300, substations S 310a . . . 310n are each connected to neighboring substations S by corresponding ones of field switches 312a . . . 312n that is normally open, and are further supplied with generated energy 302 by transmission line 304 and sub-transmission lines 306.

DERM 101 may serve to reduce any complexity or confusion arising from a proliferation of devices or systems of different types and purposes from different suppliers on a distribution grid that would otherwise complicate distribution grid management, for example by implementing standard protocols for communication, data exchange, monitoring, or control developed by industry or regulatory authorities. Thus, DERM 101 may be utilized in scenarios wherein power system operators seek to change system topology from traditional radial layouts to looped or meshed models to add reliability, accommodate changing customer needs, or adapt to real-time system operating conditions.

Grid 300 includes field switches 312a . . . 312n that enable the electrical connection or isolation of distribution grid subsections under grid operator or automated system control. Field switches 312a . . . 312n may be kept in a normally-open or normally-closed state. When a normally-open switch is closed, it connects adjacent distribution grid subsections that are normally disconnected from one another. When a normally-closed switch is opened, it disconnects adjacent distribution grid subsections that are normally connected to one another. By closing switches that are normally opened, the distribution system topology can be changed from radial to looped or meshed to add additional reliability and other benefits to the system.

Devices attached to electricity distribution grids or customer premises, e.g., devices 212a . . . 226n, may additionally be equipped with metering or sub-metering devices that measure current, voltage, impedance, inductance, capacitance, power factor or other characteristics of electric power flow for purposes of billing, monitoring or enabling control of electric system assets. Such metering or sub-metering devices may communicate with DERM 101 via advanced metering infrastructure (AMI) systems or other communication means, enabling said DERM to further inform or optimize its dispatch or other control actions.

Electricity distribution grid assets, such as relays, field switches, reclosers, capacitor banks or transformers, and devices or systems to perform demand-side management, electrical energy storage, etc. may be communicatively connected with grid operations centers via telemetry for purposes including data exchange, monitoring and control. Such telemetric connections may become more widespread as additional systems and devices with embedded intelligence are deployed in distribution grids.

DERM 101 benefits existing utility grid management systems 102 (see FIG. 1), such as EMS, SCADA, DMS or OMS systems, by facilitating a communicative connection with devices or systems for electrical energy storage or asset management systems to thereby manage demand-side assets such as energy storage devices, electric vehicles or air conditioners, for purposes of data exchange, monitoring or control.

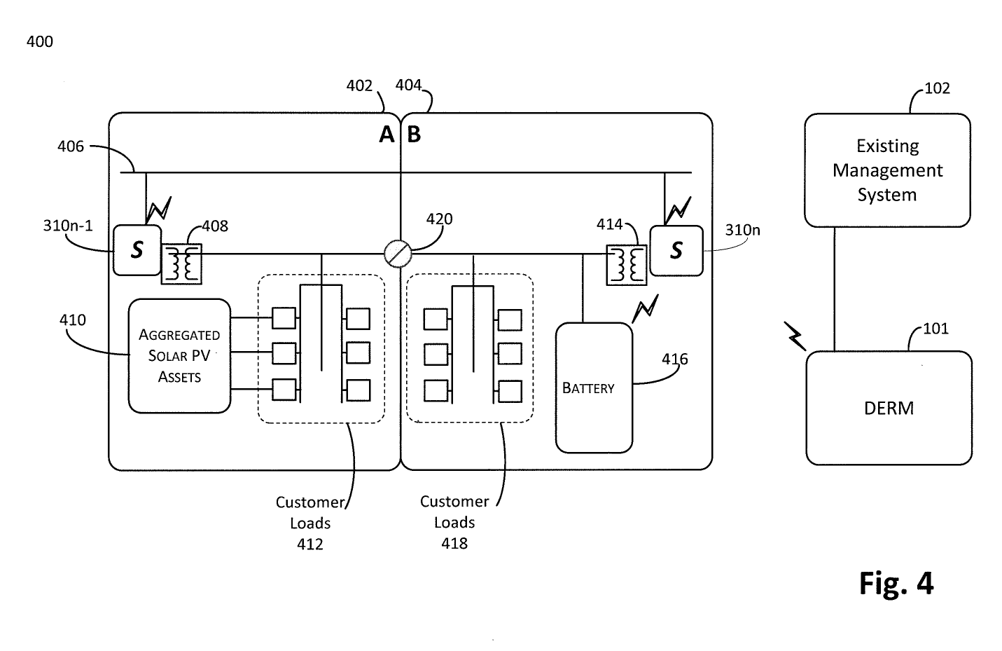

FIG. 4 shows an example system 400 to describe a sample management scenario among DERM 101, existing management system 102, and transformer 414.

In the example system configuration of FIG. 4, DERM 101 responds to a transformer 414 overload condition reported by existing management system 102, acts to relieve the overload, and facilitates the storage of excess clean power produced by solar photovoltaic (PV) panels 410, whereby such power may otherwise not be able to be utilized in such an optimal manner.

Non-exclusive example scenarios of distributed energy resource management by DERM 101 follow.

In at least one management scenario depicted in FIG. 4, DERM 101 communicates with customer-owned solar PV assets in Zone A 402, battery assets in Zone B 404, the substations 310n-1 and 310n respectively serving each zone, and existing management system 102. Existing management system 102 may determine that transformer 414 serving loads in Zone B is loaded beyond its optimal thermal limit and therefore may dispatch a request for help to DERM 101 to rectify the situation. This message may contain parameters that inform DERM 101 of the amount of additional power needed by Zone B 404 in order to relieve transformer 414 overload.

In response to the request for help, DERM 101 may search through its asset table and determine that corresponding solar PV assets 410 are steadily producing excess power at a level that cannot be consumed in Zone A 402. DERM 101 may further determine that a battery asset 416 in Zone B 404 that normally relieves heavy loading has been depleted and has a low level of available energy stored thereat. DERM 101, being aware of topology information managed by the existing system, may then calculate that closing the normally-open field switch 420 separating Zone A 402 from Zone B 404 may allow solar PV assets 410 in Zone A 402 to supply power to Zone B 404, thus relieving the overloaded transformer 414 in Zone B 404.

In a second management scenario depicted in FIG. 4, DERM 101 may dispatch an instruction to existing management system 102 requesting that field switch 420 be closed, which would allow power to flow from Zone A 402 to Zone B 404 through an alternate path. Assuming a telemetric connection between existing management system 102 and field switch 420, this instructed configuration may be implemented to reduce the load of transformer 414 in Zone B 404 to acceptable operating limits.

In accordance with a third management scenario depicted in FIG. 4, DERM 101 may determine that the presence of solar PV assets 410 in Zone A 402 renders the available power to service customer 412 loads in Zone B 404 to be sufficient, and therefore DERM 101 may dispatch instructions for battery assets 416 in Zone B 404 to begin charging.

One more management scenario depicted in FIG. 4 calls for DERM 101 to notify existing management system 102 that field switch 420 may be returned to its normally open state when battery assets 416 in Zone B 404 are fully charged and load conditions in Zone B 404 have returned to typical levels, thus avoiding transformer overloads.

As shown by the above-described scenarios, DERM 101 may be used to manage remote energy distribution over a given grid over a variety of scenarios, which include, though not exclusively, the following:

If aggregated solar PV assets 410 are actually dispersed within Zone A 402, DERM 101 may actually aggregate the assets into a single “virtual” zonal asset. Variations of such dispersed assets, which may ultimately be aggregated into a single “virtual” asset by DERM 101, include solar PV assets dispersed throughout both zones of the distribution grid, on customer premises, or both; battery assets 416 dispersed throughout Zone B 404; battery assets being deployed throughout both zones of the distribution grid, on customer premises, or both.

Further, DERM 101 may manage assets from multiple manufacturers and/or suppliers to balance power supply and demand in accordance with any of the aforementioned scenarios; and may further control assets so as to improve the reliability and/or economy of distribution grid operation in real time.

It should be noted that assets including, but not limited to, solar PV assets 410 and battery 416, may be managed by DERM 101 so as to increase infrastructure lifetime by, e.g., discharging battery 416 or changing system topology to reduce loading, and thus thermal wear on transformers, feeders or other distribution grid assets. As noted above, system operators may define overload conditions for such assets as well as associated financial costs specific to the grid, thus allowing for the most efficient response to changing load conditions.

It should be further noted that, if no existing management system 102 exists or no connection has been established or is able to be established between existing management system 102 and field switch 420 contrary to the depiction in FIG. 4, and a telemetric connection exists between DERM 101 and field switch 420, DERM 101 may directly control field switch 420 and thus entirely manage the example scenarios described above in the context of FIG. 4 with no reliance on existing management system 102 or any other external system.

DERM 101 may further provide management capabilities in arbitrary asset classes that include, but are not limited to, the following:

A. Load classes, which include (1) non-deferrable loads that may or may not have communication capabilities, such as lighting, computers, TVs, vacuums, and kitchen appliances; (2) thermostatically controlled deferrable and interruptible loads, such as private and commercial HVAC, water heaters, and dryers; and (3) non-thermostatically controlled deferrable loads, such as dish washers, washing machines, bread makers, etc;

B. Mobile load and storage classes, which include PHEV, EV, mobile battery arrays, etc.;

C. Fixed storage classes, which may be inverter connected assets, such as distributed battery storage, large battery banks, etc. or synchronous generators/motors, such as pumped storage, compressed air, etc.;

D. Distributed generation classes, which may be inverter connected intermittent (PV, DC Wind), inverter connected dispatchable (fuel cell), induction generator (small wind, industrial generator), synchronous generator (diesel and gasoline generators, micro-turbines, wind, hydro), combined heat power, etc.;

E. Protection classes, which may include breakers, relays, switches, etc.;

F. Metering and measurement classes, which may include phasor measurement units (PMU), smart meters, transformer temperature gauges, etc.; and

G. Voltage control classes, which may include active voltage controls (STATCOM, synchronous condensers), passive voltage controls (switched fixed capacitors, switched fixed reactors, SVC, transformer taps), etc.

Further still, DERM 101 may be regarded as a platform for implementing optimization algorithms related to an electricity distribution grid and corresponding customer premises for managing flows of electric power among the distribution grid and customer-owned assets. Such algorithms may be incorporated directly within DERM 101 or developed by a third party and hosted by DERM 101 as a means, for example, of enabling user-extensibility of DERM capabilities. Such algorithms may include:

A. Volt-VAR optimization changes. New volt-VAR optimization algorithms optimize not only the traditional assets of tap changers, SVCs, STATCOMs, etc., but also take into account topology changes, demand response, and storage dispatch which can reduce the currents flowing on certain feeders and therefore raise voltage levels. In such an optimization, all inverter connected distributed energy resources (PV arrays, EVs, Battery Storage) would have variable control as well;

B. Optimal distribution power flow. Topology, storage, and demand response assets can be managed within a single real-time optimization process. Additional data harvesting, enabled by the real-time optimization process, may further enable solving for optimal asset utilization for the entire system daily usage, including, for example:

1) EV assets' most probable travel destinations would be included so adequate power would be available at the time they would arrive and plug in;

2) Wind and solar forecasts for different locations; and

3) Forecasts and probable locations would be updated as often as necessary to ensure the most accurate system plan.

Algorithms implemented by DERM 101 may serve to minimize customer impact from system faults in real time and on a daily basis. Thus, DERM 101 may serve to manage storage, distributed generation, load, and switches to ensure that if grid power cannot be rerouted to the customers in the event of a feeder loss, that distributed energy resources allow individual customers and microgrids to operate safely, though isolated, as long as possible or until the line section is repaired. Advanced controllers may seamlessly resynchronize frequencies at reconnection.

DERM 101 may further enable optimal extension of infrastructure lifetime. Demand response, storage, and topology changes would work in harmony with distributed generation and forecasted distributed generation and EV movement throughout the grid to optimally extend the operation life of transformers, breakers, feeders, as well as the distributed energy resources and switches themselves. Operating the distribution system in this manner could also extend the operational lifetimes of larger and more costly transmission assets.

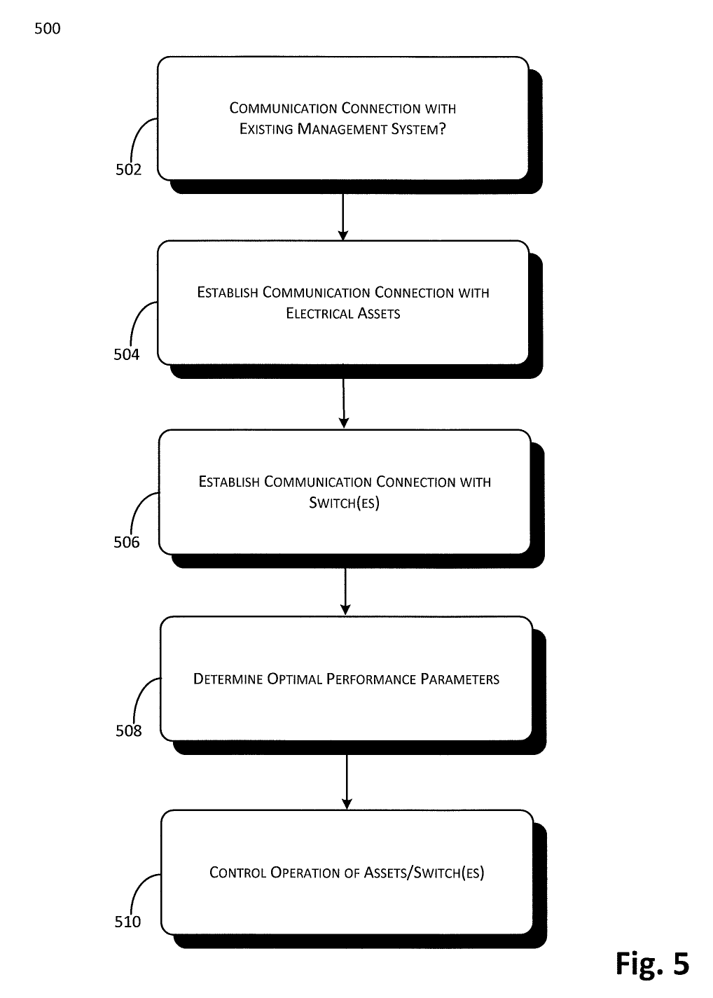

FIG. 5, therefore, provides an example management, or communication, flow 500 to broadly summarize the scenarios described above. In particular, flow 500 broadly describes basic actions taken by DERM 101 in the management of flows of information between electrical assets and interacting software assets to thereby manage performance of at least the electrical assets.

Block 502 includes DERM 101 determining whether communication with one or more utility grid management systems, e.g., SCADA, EMS, DMS, or OMS exists. If so, the following actions may be implemented with such utility grid management system acting as an intermediary. However, as set forth above, if no such connection has been established or is able to be established, DERM 101 may directly control field switches and thus manage the example scenarios described above.

Block 504 includes DERM 101 establishing communication with electrical assets that are owned by an electric utility and located within a distribution grid or that are owned by an electric utility's customer and located on the customer's premises. More particularly, communication between DERM 101 and the aforementioned electrical assets may occur over any available communication channel or combination of channels, and further may involve other components, such as utility-owned smart meters or customer-owned energy management terminals.

Block 506 includes DERM 101 establishing communication with field switches in associated electricity distribution grids. As set forth above, such communication may occur over any available communication channel or combination of channels, and further may involve other components.

Block 508 includes DERM 101 determining an optimal solution in response to any communications received from any of the existing management system, electrical assets, or field switches. For example, in response to an overload message from a transformer, DERM 101 may search a corresponding asset table and determine that corresponding solar PV assets are producing excess power at a level that cannot be consumed in one zone of an associated electricity distribution grid, and therefore such excess power should be diverted to a battery asset in another zone of the electricity distribution grid to relieve the aforementioned overload condition.

Block 510, therefore includes DERM 101 controlling operation of the assets/switches by, e.g., re-configuring a topology of the electricity distribution grid by closing a normally-open field switch separating the aforementioned zones, so that the diversion of distribution of power may occur.

Of course, the scenario described above with regard to flow 500 is to serve only as an example, and many variations thereof may occur under the management of DERM 101, yet still within the scope of flow 500.

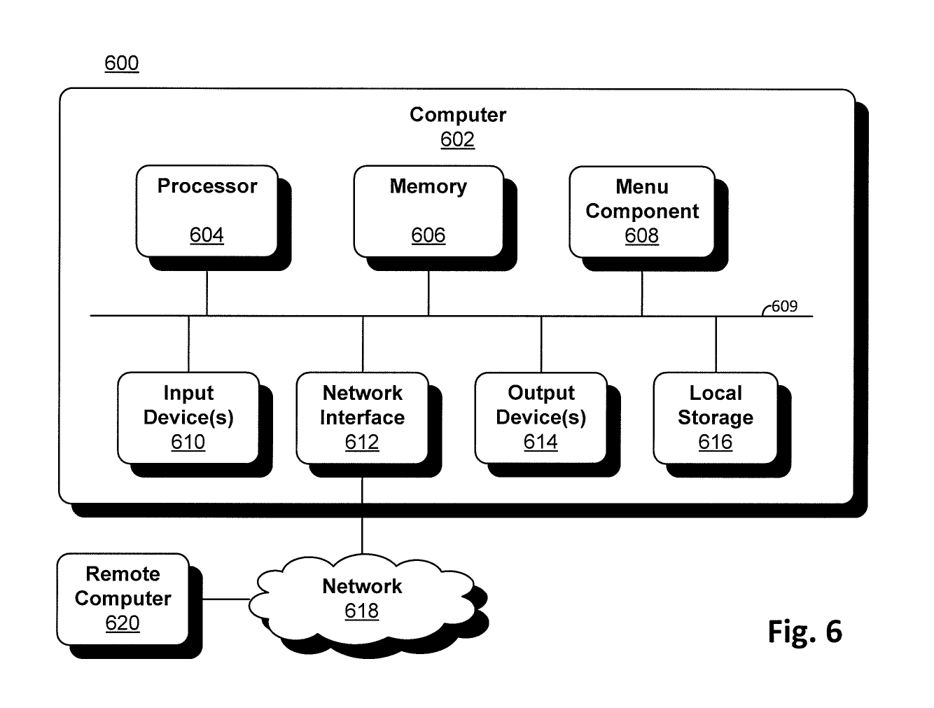

FIG. 6 illustrates a general computer environment 600, which can be used to implement the techniques described herein. The computer environment 600 is only one example of a computing environment and is not intended to suggest any limitation as to the scope of use or functionality of the computer and network architectures. Neither should the computer environment 600 be interpreted as having any dependency or requirement relating to any one or combination of components illustrated in the example computer environment 600.

Computer environment 600 includes a general-purpose computing device in the form of a computer 602, which may include one or more processors or processing units 604, system memory 606, menu component 608, and system bus 609 that couples various system components including processor 604 to system memory 606 and to menu component 608.

System bus 609 represents one or more of any of several types of bus structures, including a memory bus or memory controller, a peripheral bus, an accelerated graphics port, and a processor or local bus using any of a variety of bus architectures.

Computer 602 may include a variety of computer readable media. Such media can be any available media that is accessible by computer 602 and includes both volatile and non-volatile media, removable and non-removable media.

System memory 606 includes computer readable media in the form of volatile memory, such as random access memory (RAM), and/or non-volatile memory, such as read only memory (ROM) or flash RAM. Basic input/output system (BIOS), containing the basic routines that help to transfer information between elements within computer 602, such as during start-up, is stored in ROM or flash RAM. RAM typically contains data and/or program modules that are immediately accessible to and/or presently operated on by processing unit 604.

Computer 602 may also include other removable/non-removable, volatile/non-volatile computer storage media.

Any number of program modules can be stored on local storage 616, including e.g, an operating system, one or more application programs, other program modules, and program data 632.

A user can enter commands and information into computer 602 via input devices 610 such as a keyboard, a pointing device, or by touch. These and other input devices are connected to processing unit 604 via input/output interfaces that are coupled to system bus 609, but may be connected by other interface and bus structures, such as a parallel port, game port, or a universal serial bus (USB).

Computer 602 can operate in a networked environment using logical connections to one or more remote computers, such as remote computing device 620. By way of example, remote computing device 620 can be a PC, portable computer, a server, a router, a network computer, a peer device or other common network node, and the like.

In a networked environment, such as that illustrated with computing environment 600, program modules depicted relative to computer 602, or portions thereof, may be stored in a remote memory storage device. By way of example, remote application programs reside on a memory device of remote computer 620, such as a server hosted by a service provider or vendor, connected by network 616.

Various modules and techniques may be described herein in the general context of computer-executable instructions, such as program modules, executed by one or more computers or other devices. Generally, program modules include routines, programs, objects, components, data structures, etc. for performing particular tasks or implementing particular abstract data types. Typically, the functionality of the program modules may be combined or distributed as desired in various embodiments.

An implementation of these modules and techniques may be stored on or transmitted across some form of computer readable media. Computer readable media can be any available media that can be accessed by a computer. By way of example, and not limitation, computer readable media may comprise “computer storage media” and “communications media.”

“Computer storage media” includes volatile and non-volatile, removable and non-removable media implemented in any method or technology for storage of information such as computer readable instructions, data structures, program modules, or other data. Further still, such computer storage media does not necessarily have to be local relative to computer 602. As “cloud computing” technologies continue to develop, such storage media may include servers that are hosted by service providers or vendors.

“Communication media” typically embodies computer readable instructions, data structures, program modules, or other data in a modulated data signal, such as carrier wave or other transport mechanism. Communication media also includes any information delivery media. The term “modulated data signal” means a signal that has one or more of its characteristics set or changed in such a manner as to encode information in the signal.

While example embodiments and applications of distributed energy resource management have been illustrated and described, it is to be understood that the embodiments are not limited to the precise configurations and resources described above. Various modifications, changes, and variations apparent to those skilled in the art may be made in the arrangement, operation, and details of the methods and systems of distributed energy resource management disclosed herein without departing from the scope of the claimed embodiments.

One skilled in the relevant art may recognize, however, that distributed energy resource management may be practiced without one or more of the specific details, or with other methods, resources, materials, etc. In other instances, well known structures, resources, or operations have not been shown or described in detail merely to avoid obscuring aspects of distributed energy resource management.

We claim:

1. A method, comprising:
establishing an external communication connection with one or more electrical assets connected to an electricity distribution grid;
establishing an external communication connection with one or more utility-managed devices within an electricity distribution grid; and
controlling operation of either of the electrical assets and utility-managed devices based on messages received from at least the electrical assets to thereby optimize a flow of electric power within the electricity distribution grid.

2. The method of claim 1, wherein an electrical asset is located within the electricity distribution grid which is owned by an electric utility.

3. The method of claim 1, wherein an electrical asset is located on the premises of a customer of an electric utility.

4. The method of claim 1, wherein at least one of the electrical asset stores energy.

5. The method of claim 1, wherein at least one of the electrical assets generates power.

6. The method of claim 1, wherein at least one of the electrical assets corrects a power factor.

7. The method of claim 1, wherein at least one of the electrical assets implements demand-side management of electrical loads.

8. The method of claim 1, wherein at least one of the electrical assets charges or discharges electric vehicles.

9. The method of claim 1, wherein at least one of the electrical assets improves power quality.

10. The method of claim 1, wherein the controlling includes aggregating the electrical assets and managing the aggregation as a single asset.

11. The method of claim 1, wherein the electrical assets are produced by multiple distinct manufacturers.

12. The method of claim 1, wherein the controlling includes balancing power consumption with available power within the electricity distribution grid.

13. The method of claim 12, wherein the available power is produced within the electricity distribution grid.

14. The method of claim 12, wherein the available power is produced external to the electricity distribution grid.

15. The method of claim 1, wherein the controlling includes managing performance of at least one of the electrical assets to improve reliability of the electricity distribution grid.

16. The method of claim 1, wherein the controlling includes managing performance of at least one of the electrical assets to minimize costs associated with operating the electricity distribution grid.

17. The method of claim 1, wherein the controlling includes managing performance of at least one of the electrical assets to minimize the generation of pollutants produced in the course of operating an electricity distribution grid.

18. The method of claim 17, wherein a pollutant is a greenhouse gas.

19. The method of claim 1, wherein the one or more utility-managed devices includes at least one or more of a switch, a relay, a recloser, a transformer, or a capacitor bank.

20. The method of claim 1, wherein the one or more electrical assets are equipped with a metering or sub-metering device to measure one or more electric power characteristics.

21. The method of claim 20, wherein the controlling is based at least in part upon the one or more measured electric power characteristics.

22. The method of claim 1, wherein the external communication connections is established through an existing utility grid management system.

23. The method of claim 22, wherein the existing utility grid management system is a distribution management system (DMS).

24. The method of claim 22, wherein the existing utility grid management system is an energy management system (EMS).

25. The method of claim 22, wherein the existing utility grid management system is a Supervisory Control and Data Acquisition (SCADA) system.

26. The method of claim 22, wherein the existing utility grid management system is an outage management system (OMS).

27. The method of claim 1, wherein one or more of the electrical assets are controlled by an external aggregation platform and an energy output or consumption thereof is aggregated by the external aggregation platform.

28. A computer-readable medium, including computer-readable instructions, which when executed by a computing system, causes one or more processors to:
direct a distributed energy resource manager (DERM) to establish an external communication connection with one or more electrical assets (devices or systems) connected to an electricity distribution grid;
establish an external communication connection with one or more switches within an electricity distribution grid; and
optimize the flow of electric power within said grid by effecting control actions upon said electrical assets and/or switches, as described in claim 1.
